(19) United States
(12) Patent Application Publication
(10) Pub. No.: US 2004/0094514 A1
(43) Pub. Date: May 20, 2004

(54) Automatic orbital welding machine, and a welding process for pipes of a bundle of a heat exchanger

(75) Inventors: Alessio Nista, Spinea VE (IT); Giorgio Rossi, Padova (IT); Walter Prendin, Chirignago VE (IT)

Correspondence Address: BROWDY AND NEIMARK, P.L.L.C., 624 Ninth Street, N.W., Washington, DC, 20001, US

(73) Assignee: Tecnomare S.p.A., Venezia ve (IT)

(21) Appl. No.: 10/385,293

(22) Filed: Mar. 11, 2003

(30) Foreign Application Priority Data
Mar. 11, 2002 (IT) RM2002A000132

(51) Int. Cl. B23K 9/12

(52) U.S. Cl. 219/60.2; 219/125.11

(57) ABSTRACT

The present invention relates to an electric arc automatic orbital welding machine (3) for carrying out butting welding between pipes of a bundle (2) and a cylindrical body (1) in heat exchangers, in which a cam mechanism (5) receives a circular motion around an axis (9) therefrom and generates an axial reciprocating motion along the same axis (9) and orthogonal to the plane of rotation so that the torch (7) describes the same spatial path which coincides with the intersection line between the pipe segment (2) and the cylindrical body (1).

### BACKGROUND OF THE INVENTION

1. Field of the Invention

The present invention concerns an automatic orbital welding machine, as well as a welding process for joining pipes of a bundle to cylindrical bodies of larger diameter, preferably header cylindrical bodies and particularly, yet not exclusively, for the manufacturing of heat exchangers. More precisely, the term welding is meant to indicate the seamless joining of preferably metallic pieces or surfaces, obtained by heating, with or without welding material. More precisely, within the definition of “welding” there fall both the joining of parts locally subjected to a melting, and those connections obtained by effect of the melting of a so-called brazing material interposed therebetween, as well as all the intermediate arrangements commonly called braze welding.

2. Discussion of the State of the Art

The already known heat exchangers are employed as components destined to transfer heat in various power plants. Such elements are essentially made with a geometric configuration, e.g. cylindrical or other, destined to the housing of pipes of a bundle inside which there is conveyed a fluid that, according to the plant design, could be for cooling or for heating. An important requirement for these exchangers is that of providing an effective and steady thermal insulation. Therefore, in order to meet this requirement, the quality of the welding between the conveying pipes and the heat exchanger cylinders is crucial.

As it is known in the art, in automatic orbital welding, both when the motion is conferred to the piece to be welded or to the torch, the segments of pipes to be welded at their head, e.g. generally in ducts, or in particular at the end zones between the pipes of a bundle and the heat exchangers, are maintained reciprocally side-by-side and positioned by means of coupling devices for exerting the locking force and for keeping the accurate reference position thereof.

Likewise, it is known that a welding head of an automatic orbital welding machine deposits a molten weld bath at its first-run, or root bead, onto the outside surface of the pipes at the chamfer bottom thereof, or welding chamfer, which is advantageously preset onto the head of the pipe to be welded to, e.g. to a cylindrical heat exchanger.

However, this known type of welding for pipes of a bundle for heat exchangers entails several drawbacks. In fact, the so designed welding head for orbital welding machines has for a long-time been used for welding head-to-head connections between pipes or cylinders of equal diameter, being therefore the intersection line a circle.

Sometimes, within said head-to-head connection between segments of pipes of equal diameter, exhibits pipes having a slightly ovalized or anyhow uneven section. At the uneven zones, the welding head though being self-adjust-able, may form cavities and/or defects onto the melting bath. The presence of such cavities or defects on one hand sensibly compromises the weld strength and the continuity of the inside surface of the pipe, and on the other hand is hardly detectable and curable.

Another serious drawback of the known automatic orbital welding machines lies in the fact that the welding with electric arc generates unevenness in the weld bath, mostly during the very first pass, and in all those cases in which there is a chamfer unevenness or a wrong or accidental positioning between the two pipes, or the two cylinders or cylinder and pipes of a bundle.

In such a case of welding between cylinder and pipe segments, the intersection line is generated by two perpendicularly intersecting different-diameter cylinders. Hence, the welding line has a spatial development and the melting process produced by the electric arc proceeds under unstable conditions as the torch supporting the inert gas nozzle and the electrode does not follows the same intersection line of the two abovementioned cylinders, causing an substantial weakening of the strength of the root or first-run bead.

### SUMMARY OF THE INVENTION

The main object of the present invention is to provide a welding head for an automatic orbital welding machine which eliminates the drawbacks of the welding machines of the art, for welding connections between equal-diameter cylinders, and in particular for welding different-diameter cylinders, in order to provide a correct performing thereof and perfect mechanical strength.

Another important object of the present invention is to provide a welding head capable of eliminating the formation of cavities and defects in a spatial intersection line generated by two different-diameter cylinders, even in ovalized or anyhow different-diameter pipes, in order to realize a anyhow correct, sturdy and perfectly continuous welding.

A further object of the invention is to provide a welding process, in particular for carrying out the welding between two different-diameter cylinders having an intersection line that is spatial or projected on a plane, or ovalized, or anyhow not circular, in order to obtain a welding bead which exhibits no first-run weld bath imperfections; the welding process according to the present invention being capable of overcome the faulty operation of the already known systems of the state of the art for the joining of a segment of pipe arranged in a manner having its cross section at the intersection line to the heat exchanger cylinder, overcoming any chamfer imperfections or other incidental causes.

According to the present invention, these and other important objects are obtained by an automatic orbital welding machine having the features as set forth by the claims hereinafter.

Substantially, the invention is based on a mechanism that, receiving the rotary motion from the basic automatic orbital welding machine to which is connected, also generates a motion which is orthogonal to the plane of rotation so that the coupled torch describes the intersection line generated by the two different-diameter cylinders which are respectively intersected perpendicularly by their welded union.

The invention provides a composite motion of the welding torch by means of a cam designed with an operating contour that, besides from driving the rotary motion, gives to the welding torch also an swinging motion according to the axis of rotation corresponding to the sequence of laws of motion, in order to follow the spatial intersection line between the two cylinders to be welded head to head.

### BRIEF DESCRIPTION OF THE DRAWINGS

The features, the aims and the advantages of the orbital welding machine and the welding process related to, which are the subject-matter of the present invention will be apparent from the following detailed description thereof with reference to the annexed drawings, given by way of non-limiting example, wherein:

FIG. 1 is a schematic axonometric perspective view showing the electric-arc automatic orbital welding machine of the present invention positioned around a pipe of a bundle for the joining of the same to a cylindrical heat exchanger, by means of a welding bead, onto which the latter rests advantageously on shaped supporting legs;

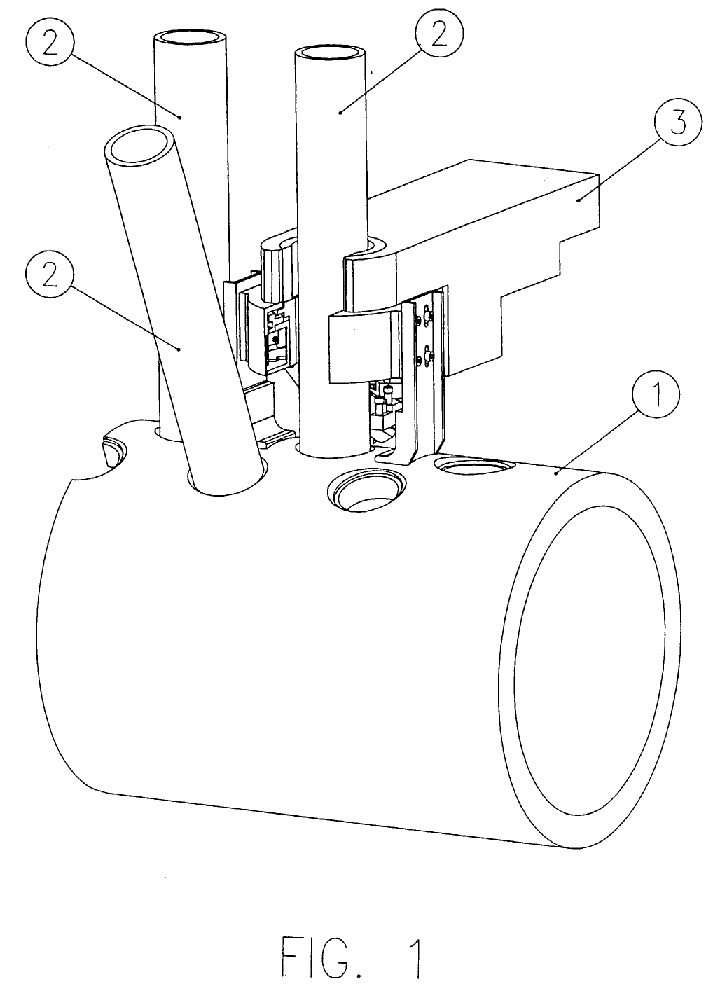

FIG. 2 is an axonometric perspective view showing the whole arrangement of the orbital welding machine of the present invention, showing a rotary motion drive shaft, a cam mechanism, a head for supporting the electric arc welding units under a controlled atmosphere, a welding torch, an adjustable support for guiding a wire of a welding material, and two frame bodies anchored to the supporting legs for the positioning of the entire welding head;

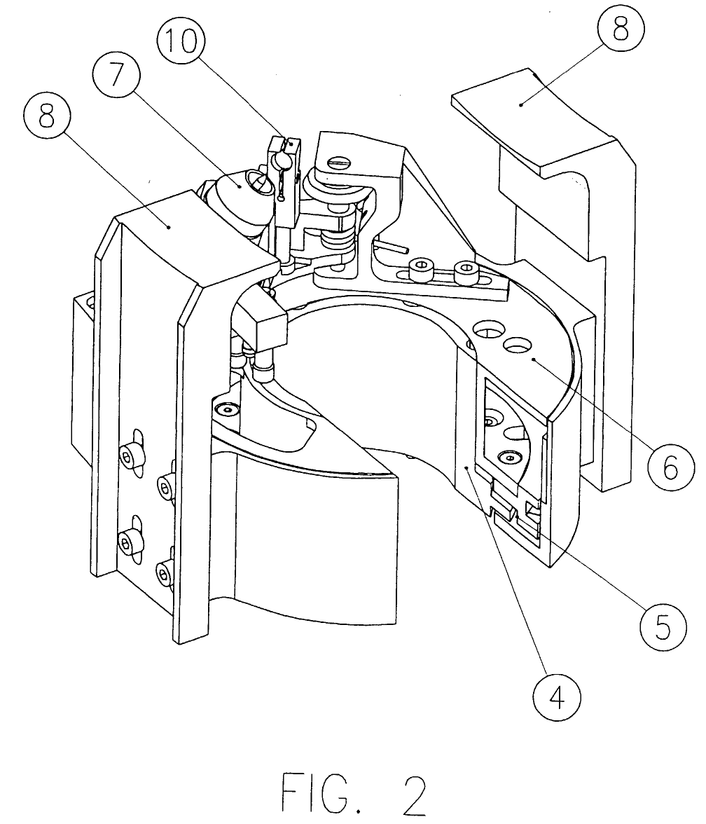

FIG. 3 is a schematic front view showing the automatic orbital welding machine of the invention anchored around to a pipe and about to start the activation of the welding torch, for a stably joining of the pipe end to the cylindrical heat exchanger; and

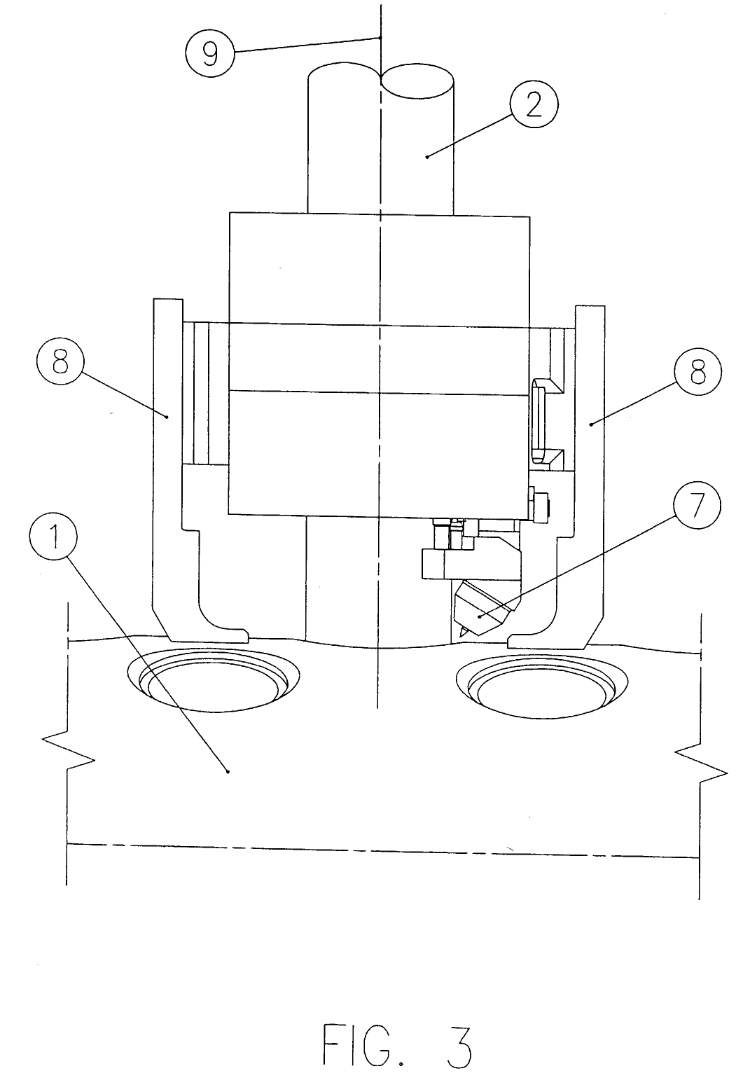

FIG. 4 is an exploded perspective view of the mechanical members that when assembled form the welding head.

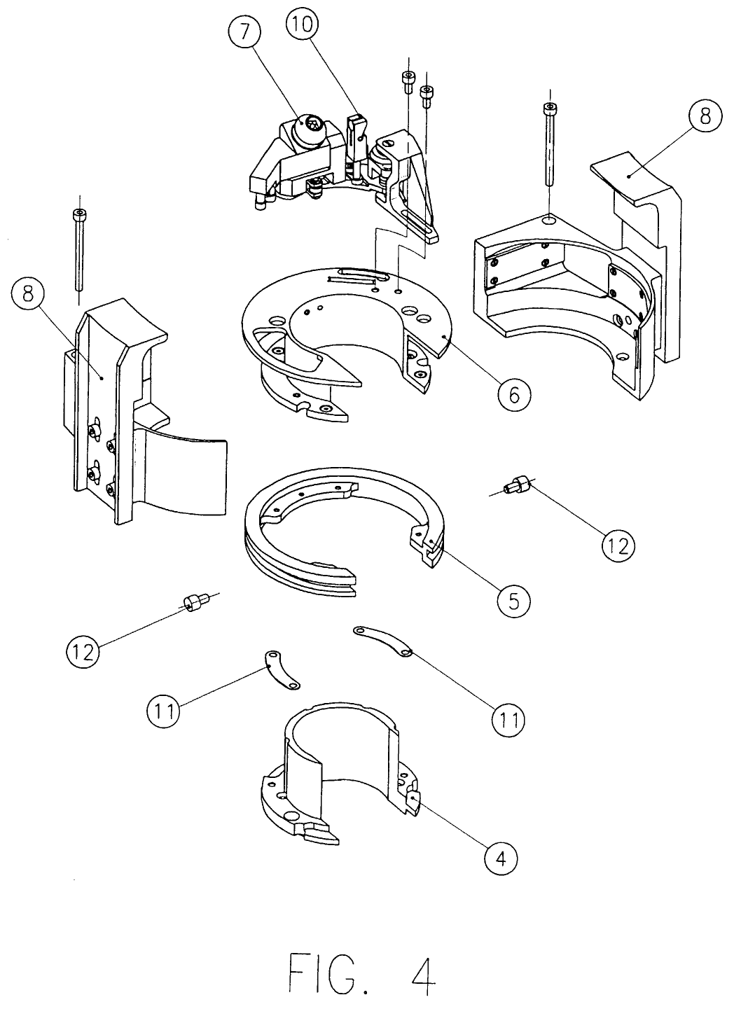

### DETAILED DESCRIPTION OF THE INVENTION

In the figures, same parts will have same reference numbers. With reference to the figures, 1 is a cylindrical body which encloses a bundle 2, preferably of the kind with thick wall for pressurized heater; 2 is a substantially cylindrical pipe of the bundle 2 which radially converges at the intersection to the cylindrical body 1; 3 is the frame body for anchoring the welding head of the orbital welding machine; 4 is the drive shaft of the rotary motion of the welding head; 5 is the cam mechanism which receives the rotary motion from the drive shaft 4, it being integral to the latter by removable connecting means, i.e. screw or the like, and provides by means of its contour and by a coupling to at least one mechanical element 12, an axial reciprocating motion along the axis 9 of the pipe 2 and, therefore, a perpendicular motion to the plane of rotation, so that a welding torch 7 moves along the spatial development intersection line between the end of the pipe 2 and the cylindrical heat exchanger 1; 6 is a frame member designed with a shape for advantageously supporting the welding head, the latter being connected and positioned thereto with removable screw means; 7 is the welding torch for striking the electric arc preferably under controlled inert gas atmosphere for stably joining, by means of at least one welding material bead, the pipe end 2 to the cylindrical body heat exchanger (heater) 1; 8 is a supporting leg of the welding head, and being designed to be anchored and positioned around the pipe 2 of a bundle. The leg 8 is advantageously shaped to allow a very stable telescopic support onto the cylindrical surface of the heat exchanger 1; 9 is an axis of the pipe 2 of the bundle, as well as the axis of the reciprocating motion of the welding torch 7. Said axis 9 is substantially orthogonal to the axis of the cylindrical heat exchanger 1, and therefore is orthogonal to the plane which is tangential to the point of intersection to the cylindrical surface of the latter; 10 is the support member of the welding material, i.e. the wire for generating the welding bead, said support 10 advantageously being adjustable in height and angle by means of a preferably micrometric adjusting device; 11 are elastic blades, preferably in harmonic steel, which are mounted at one end to the circular motion drive shaft 4, and at the other end thereof to the cam mechanism 5 in order to allow both the rigid transmission of the circular motion to the welding head and the axial reciprocating motion between the rotating shaft 4 and the welding head. More precisely, said blades 11 allow the axial reciprocating motion of the welding torch 7 and the support member 10 of the welding material, along the axis 9; 12 are mechanical members for co-operating with a groove of the cam mechanism 5 in order to generate the reciprocating motion of the welding head. Said mechanical members 12 have advantageously the shape of a pin in order to give a low sliding friction with the profile of the groove of the cam 5, and they are also fixed to the welding head frame at a stationary position.

Will be given now the description of the operation of the automatic orbital welding machine of the present invention. According to the invention, at first the welding machine is preset for carrying out butting and/or joining welding between the pipes 2 of a bundle and the cylindrical body of the heat exchanger 1. More precisely, an electric generator, a bath-shielding gas supply unit, a welding material wire supply unit, and other connections are connected to the machine in a manner already known to the art and to those skilled in the art.

Following, the operator aligns the inlet opening of the welding machine to a pipe 2 to be welded onto the cylindrical body 1. Then, the operator places the welding head and its frame 3, together with the frame member 6 and the drive shaft 4, in a manner to embrace the pipe 2.

Then, the operator positions the welding head by means of the supporting legs 8 onto the cylindrical surface of the heat exchanger 1, in order to correctly position the welding head by making axial adjustments as well as angle orientation, by means of preferably mechanical members, like slots and removable screws.

The welding machine, once correctly positioned, is steadily blocked around the pipe 2 by a locking device such a vice (not shown), which is manually actuated by the operator, the vice device being of the already known-ain the art devices.

The operator micrometrically adjusts the positioning of the welding torch 7 by means of screw members, or by means of alike members, therefore allowing an accurate and millimetric axial positioning of the torch for depositing the welding bead (not illustrated). Then, the inert gas conveying pipe, and the cooling water are activated, as well as other complementary activations all known to the art. At this stage, the operator activates the welding start push button and the automatic orbital welding machine of the present invention starts to deposit the first-run bath onto the external surface of the pipe 2 at the chamfer bottom, which is advantageously preset at the head of the pipe, or partially onto the hole of the cylindrical heat exchanger 1.

The welding is always carried on automatically, with one or more welding runs in order to correctly join the pipe 2 to the cylindrical body 1 of the heat exchanger.

The welding steps for depositing one or more welding beads are controlled by a program of a control unit of the already known in the art, overseeing all the automatic operations required to the complete carrying out of the welding and its perfect tightness, also in the presence of high operating pressures.

### CONCLUSIVE STATEMENT

A preferred embodiment of the invention has hereto been described by way of example, however different embodiments are possible without departing from the scope of the same. Accordingly, parts may be taken out or added, and the shapes and dimensions of the mechanical components may vary. Likewise, different embodiments may be realised for the synchronizing means and/or on the actuating means like mechanical, electrical, pneumatic devices, etc., without departing from the basic concept of the invention.

What is claimed is:

1. An electric arc automatic orbital welding machine (3) for carrying out butting welding between pipes of a bundle (2) to a cylindrical body (1), and in particular for welding pipes of a bundle (2) to a cylindrical body of a heat exchanger, comprising a electric current generator, a shielding gas supplying unit, a welding material supplying unit connected to said electric current generator and to said gas supplying unit including a continuous wire advancing unit, and a welding torch (7) connected to said supplying unit through a tube and a connector of the rapid clutch kind, characterized in that it has a cam mechanism (5) which cooperates with the circular motion from the orbital welding machine (3), and having a contour which generates a motion along an axis (9) orthogonal to the plane of rotation so that the welding torch (7) describes the spatial development intersection line between the pipe segment (2) and the cylindrical heat exchanger (1).

2. The electric arc automatic orbital welding machine (3) according to claim 1, characterized in that the cam mechanism (5) while transmitting the circular motion to the torch (7) provides a reciprocating motion which is controlled along the axis of rotation (9) by means of an assembled frame comprising a circular motion drive shaft (4) and a support head (6) for said welding torch (7).

3. A welding process for the butting zones between pipes of a bundle (2) to a cylindrical body (1) of a heat exchangers, characterized in that it comprises a step wherein the motion of a welding torch (7) is controlled along a path which is analogous to the spatial development intersection line between said pipes of a bundle (2) and said cylindrical body (1) of an heat exchanger.

4. The welding process according to claim 3, further characterized in that it comprises a step wherein a perfect collimation between a path of said welding torch (7) and the spatial development intersection line between a pipe (2) and a cylindrical body (1) is achieved in a continuous manner, by means of the concomitant combination of a circular motion about said axis (9) of said pipe (2) and an axial reciprocating motion along the said axis (9), said motion being perpendicular to the plane of rotation so that the welding torch (7) describes a path which coincides with the intersection line of the pipe segment (2) with the cylindrical body (1) although having substantially different diameter therebetween.
